(19) United States
(12) Patent Application Publication
(10) Pub. No.: US 2026/0032709 A1
(43) Pub. Date: Jan. 29, 2026

(54) METHODS AND APPARATUSES FOR RESOURCE SELECTION IN SIDELINK COMMUNICATION

(71) Applicant: TOYOTA JIDOSHA KABUSHIKI KAISHA, Toyota-shi, Aichi-ken (JP)

(72) Inventors: Nuno KIILERICH PRATAS, Gistrup (DK); Daniel MEDINA, Munchen (DE); Torsten WILDSCHEK, Gloucester (GB); Ling YU, Kauniainen (FI); Jun TAN, Glenview, IL (US); Takayuki SHIMIZU, Mountain View, CA (US); John KENNEY, Mountain View, CA (US); Onur ALTINTAS, Mountain View, CA (US); Hongsheng LU, Mountain View, CA (US)

(73) Assignee: TOYOTA JIDOSHA KABUSHIKI KAISHA, Toyota-shi, Aichi-ken (JP)

(21) Appl. No.: 19/116,818

(22) PCT Filed: Sep. 12, 2023
(86) PCT No.: PCT/JP2023/033212

§ 371 Date: Mar. 28, 2025

Related U.S. Application Data
(60) Provisional application No. 63/377,426, filed on Sep. 28, 2022.

(51) Int. Cl. H04W 72/40; H04W 72/25

(52) U.S. Cl. CPC H04W 72/40; H04W 72/25

(57) ABSTRACT

Disclosed are methods, apparatuses, and systems for resource selection in a sidelink communication. One of the methods includes: determining, by a user equipment (UE), a spatial filter configuration, the spatial filter configuration being associated with a first time period: collecting sensing information obtained using the spatial filter configuration, the sensing information including at least one of: sidelink resource reservation information, or at least one sidelink reference signal received power (SL-RSRP) measurement of the sidelink communication: determining one or more candidate resources based on the sensing information: selecting one or more resources from the one or more candidate resources for transmission: re-evaluating using the spatial filter configuration, the selected one or more resources; and determining, based on a result of the re-evaluating of the selected one or more resources, whether a re-selection of the one or more resources is triggered.

### CROSS-REFERENCE TO RELATED PATENT APPLICATION

This application claims the benefit of U.S. Provisional Application No. 63/377,426, filed on Sep. 28, 2022, entitled “SIDELINK RESOURCE SELECTION FOR MMW OPERATION,” the entirety of which is incorporated by reference herein.

### TECHNICAL FIELD

Apparatuses and methods consistent with the present disclosure relate generally to communications, more specifically, methods, systems, and devices for resource selection in a sidelink communication.

### BACKGROUND ART

Sidelink communication technology enables direct communication between two or more devices, for example, two or more vehicles in a vehicle-to-everything (V2X) communication. A user equipment (UE) in a sidelink communication may autonomously monitor a resource pool to determine which resources are available to be selected for one or more future transmissions. But resource selection in a sidelink communication using high frequency bands (e.g., mmWave bands) is challenging, especially when a transmitter (Tx) UE and/or a receiver (Rx) UE in the sidelink communication are moving. For a sidelink communication using a high frequency band, a Tx UE and a Rx UE usually apply spatial filters to concentrate the Tx beam and Rx beam and adjust the direction of the Tx beam and the Rx beam to a particular direction. When the Tx UE and/or Rx UE are moving, their spatial filters may also need to be adjusted to keep the alignment of the Tx beam and the Rx beam. Systems and methods for resource selection that are capable of adjusting a spatial filter of a UE are desired.

### SUMMARY OF INVENTION

According to some embodiments of the present disclosure, there is provided a UE for a sidelink communication. The UE includes a memory storing an instruction; and a processor configured to execute the instruction stored in the memory to: determine a spatial filter configuration, the spatial filter configuration being associated with a first time period; collect sensing information obtained using the spatial filter configuration, the sensing information including at least one of: sidelink resource reservation information, or at least one sidelink reference signal received power (SL-RSRP) measurement of the sidelink communication; determine one or more candidate resources based on the sensing information; select one or more resources from the one or more candidate resources for transmission; re-evaluate, using the spatial filter configuration, the selected one or more resources; and determine, based on a result of the re-evaluating of the selected one or more resources, whether a re-selection of the one or more resources is triggered.

According to some embodiments of the present disclosure, there is provided a method for resource selection in a sidelink communication. The method includes determining, by a UE, a spatial filter configuration, the spatial filter configuration being associated with a first time period; collecting, by the UE, sensing information obtained using the spatial filter configuration, the sensing information including at least one of: sidelink resource reservation information, or at least one SL-RSRP measurement of the sidelink communication; determining, by the UE, one or more candidate resources based on the sensing information; selecting, by the UE, one or more resources from the one or more candidate resources for transmission; re-evaluating, by the UE, using the spatial filter configuration, the selected one or more resources; and determining, based on a result of the re-evaluating of the selected one or more resources, whether a re-selection of the one or more resources is triggered.

According to some embodiments of the present disclosure, there is provided a non-transitory computer-readable medium storing instructions that are executable by one or more processors of a UE to perform a method. The method includes determining a spatial filter configuration, the spatial filter configuration being associated with a first time period; collecting sensing information obtained using the spatial filter configuration, the sensing information including at least one of: sidelink resource reservation information, or at least one SL-RSRP measurement of the sidelink communication; determining one or more candidate resources based on the sensing information; selecting one or more resources from the one or more candidate resources for transmission; re-evaluating using the spatial filter configuration, the selected one or more resources; and determining, based on a result of the re-evaluating of the selected one or more resources, whether a re-selection of the one or more resources is triggered.

### BRIEF DESCRIPTION OF DRAWINGS

FIG. 1A is a schematic diagram illustrating a first mode for resource allocation in a sidelink communication.

FIG. 1B is a schematic diagram illustrating a second mode for resource allocation in a sidelink communication, consistent with some embodiments of the present disclosure.

FIG. 2 is a schematic diagram illustrating a method for resource selection, consistent with some embodiments of the present disclosure.

FIG. 3 is a schematic diagram illustrating a method for determining a resource candidate set, consistent with some embodiments of the present disclosure.

FIG. 4A is a schematic diagram illustrating a first inter-UE coordination (IUC) scheme; and FIG. 4B is a schematic diagram illustrating a second IUC scheme, consistent with some embodiments of the present disclosure.

FIG. 5 is a schematic diagram illustrating a movement of a Tx UE relative to an Rx UE in a sidelink communication, consistent with some embodiments of the present disclosure.

FIG. 6 is a schematic diagram illustrating a channel sensing method in a sidelink communication, consistent with some embodiments of the present disclosure.

FIG. 7 is a schematic diagram illustrating a method for resource selection in a sidelink communication, consistent with some embodiments of the present disclosure.

FIG. 8A is a schematic diagram illustrating a method for resource selection in a sidelink communication, consistent with some embodiments of the present disclosure.

FIG. 8B is a schematic diagram illustrating a method for resource selection in a sidelink communication, consistent with some embodiments of the present disclosure.

FIG. 9A is a schematic diagram illustrating a spatial filter configuration applied for a channel sensing at a first time instance; and FIG. 9B is a schematic diagram illustrating a spatial filter configuration applied for a channel sensing at a second time instance, consistent with some embodiments of the present disclosure.

FIG. 10A is a schematic diagram illustrating a method for channel sensing in a sidelink communication; and FIG. 10B is a schematic diagram illustrating a spatial filter adjustment over time, consistent with some embodiments of the present disclosure.

FIG. 11A is a schematic diagram illustrating a method for channel sensing in a sidelink communication; and FIG. 11B is a schematic diagram illustrating a spatial filter adjustment over time, consistent with some embodiments of the present disclosure.

FIG. 12A is a schematic diagram illustrating a method for channel sensing in a sidelink communication; and FIG. 12B is a schematic diagram illustrating a spatial filter adjustment over time, consistent with some embodiments of the present disclosure.

FIG. 13 is a schematic diagram illustrating a method for channel sensing in a sidelink communication, consistent with some embodiments of the present disclosure.

FIG. 14 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

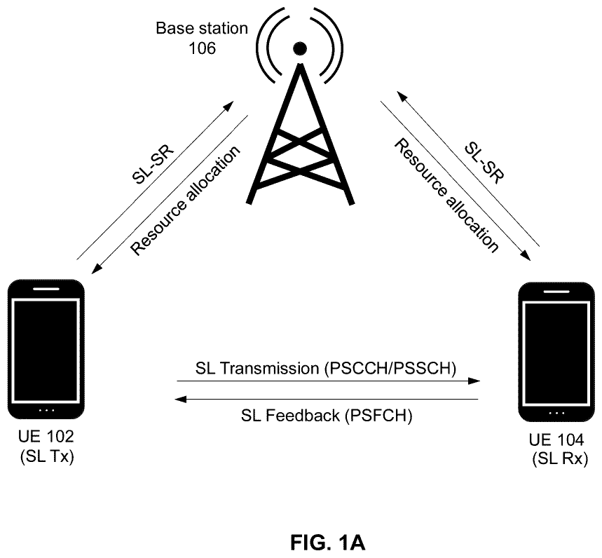

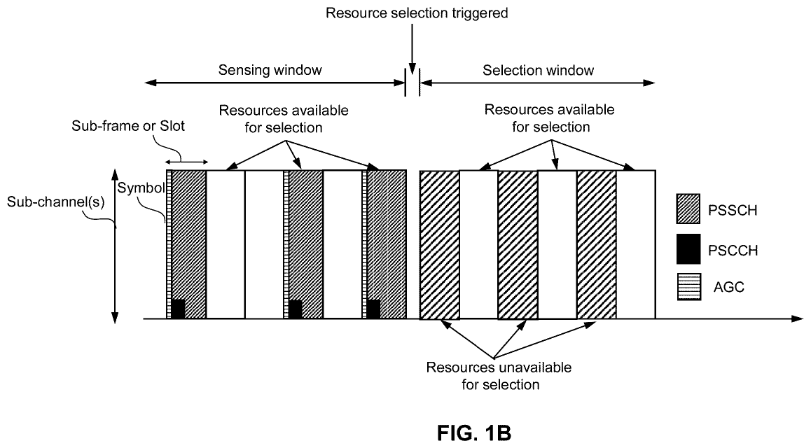

FIG. 1A is a schematic diagram illustrating a first mode for resource allocation in a sidelink communication; and FIG. 1B is a schematic diagram illustrating a second mode for resource allocation in a sidelink communication, consistent with some embodiments of the present disclosure.

Referring to FIG. 1A, a communication system includes a UE 102, a UE 104, and a base station 106. The UE 102 may be a Tx UE in a sidelink communication (SL Tx), and the UE 104 may be an Rx UE in the sidelink communication (SL Rx). The base station 106 can be any base station (e.g., gNodeB (gNB)) currently existing, such as base stations for long term evolution (LTE) or new radio (NR), or base stations for a future generation (6^{th} generation (6G), 7^{th} generation (7G), or any future generation) radio access technology (RAT). The UE 102 and the UE 104 may communicate each other using sidelink signals. For example, the UE 102 may transmit a physical sidelink control channel (PSCCH) and/or physical sidelink shared channel (PSSCH) to the UE 104, and in response, the UE 104 may transmit a feedback signal, such as physical sidelink feedback channel (PSFCH) to the UE 102. The UE 102 and the UE 104 may also communicate with one or more other UEs in the sidelink communication. The UE 102 and the UE 104 can be any form of UEs, for example, two vehicles in a V2X communication.

In a first mode for resource allocation, the UE 102 may transmit a signal, for example, a sidelink-scheduling request (SL-SR) signal to the base station 106. Upon receipt of the signal from the UE 102, the base station 106 may determine the resources to be allocated to the UE 102 and transmit a signal indicating the resource allocation to the UE 102. Similarly, the base station 106 also may be responsible for the resource allocation for the UE 104 and transmit a signal indicating resource allocation for the UE 104, upon receipt a signal (e.g., SL-SR) from the UE 104.

In the second mode for the resource allocation, the UE 102 (and similarly the UE 104) may autonomously perform resource selection with the aid of a sensing procedure. The UE 102 may perform channel sensing over the configured sidelink transmission resource pool(s), in order to obtain information about the resources reserved by other UEs. Referring to FIG. 1B, the UE 102 may perform a channel sensing (e.g., background sensing or any other type of full sensing or partial sensing) in a sensing window and collect another UE's resource reservation information, for example, based on decoding sidelink control information (SCI) included in the received sidelink signals. The UE 102 may decode the SCI based on two stages: a first stage SCI (SCI format 1-A) and a second stage SCI (SCI format 2-A or 2-B) as defined in the 3rd Generation Partnership Project (3GPP) specifications. Based on the channel sensing, the UE 102 may determine candidate resources, by excluding occupied, reserved, and/or unmonitored resources. The candidate resources may be, for example, one or more slots, subframes, or frames available for selection for the next period. As shown in FIG. 1B, the radio resources can be divided into sub-frames or slots in the time domain and sub-channels in the frequency domain. FIG. 1B shows, for example, three available sub-frames or slots in the time domain among a plurality of subframes or slots. Each sub-frame or slot may include one or more symbols for automatic gain control (AGC), one or more symbols for PSCCH, and one or more symbols for PSSCH. Once a resource selection (or reselection) is triggered, the UE 102 may select resource(s) from the available sidelink resources based on the channel sensing information.

In some embodiments, the UE 102 may be configured with one of the two modes for resource allocation. In some embodiments, the UE 102 may be configured with both modes for resource allocation. In some embodiments, the UE 102 may switch back and forth between the two modes for resource allocation.

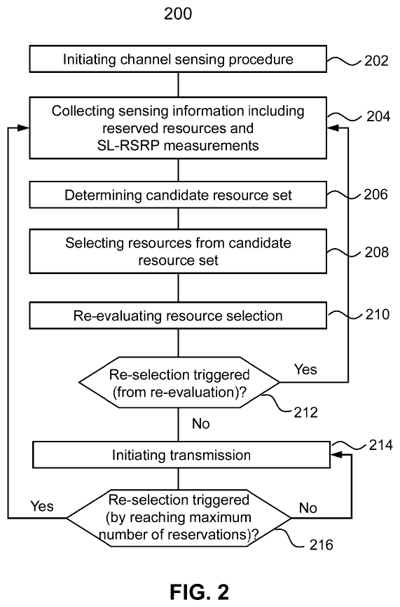

FIG. 2 is a schematic diagram illustrating a method 200 for resource selection based on the above-noted second mode, consistent with some embodiments of the present disclosure. Referring to FIG. 2, the method 200 includes a step 202 of performing a channel sensing (e.g., background sensing or any other type of full sensing or partial sensing). For example, a Tx UE in a sidelink communication, such as the UE 102 of FIG. 1 may have data to transmit. Thus, the Tx UE may initiate a channel sensing procedure for resource selection. For example, the Tx UE may perform a channel sensing in a sensing window (e.g., 100 ms or 1100 ms). In some embodiments, the Tx UE may monitor the resource pool and acquire information (e.g., resource reservation information and SL-RSRP measurements) to be used during the resource selection procedure without (prior to) knowing that it has a transmission to perform.

The method 200 includes a step 204 of collecting sensing information including reserved resources and SL-RSRP measurements. For example, the Tx UE may perform channel sensing in the sensing window and collect another UE's resource reservation information based on SCI decoding to identify candidate resources. The Tx UE may decode the SCI using two stages: a first stage SCI (SCI format 1-A) and a second stage SCI (SCI format 2-A or 2-B) as defined in the 3GPP specification.

The method 200 includes a step 206 of determining a candidate resource set. For example, after the Tx UE acquires sensing information from channel sensing, the Tx UE may determine a candidate resource set, for example, by excluding occupied, reserved, and/or unmonitored resources. The method 200 includes a step 208 of selecting resources among candidate resources. For example, the Tx UE may select resources semi-persistently, or up to a maximum number of reservations. The selection may be a random selection.

The method 200 includes a step 210 of re-evaluating resource selection. For example, the Tx UE may re-evaluate the selected resources before transmission by keeping decoding of other UEs' PSCCH, and/or measuring SL-RSRP on the PSCCH or the corresponding PSSCH.

The method 200 includes a step 212 of determining, based on the re-evaluation, whether a resource re-selection is triggered. For example, if the Tx UE determines that a resource re-selection is triggered, the method may iterate from the step 204. On the other hand, if the Tx UE determines that a resource re-selection is not triggered, the method may proceed with a step 214 of initiating a transmission of packets.

The method 200 includes a step 216 of determining whether a re-selection of resources is triggered by reaching a maximum number of reservations. For example, if the Tx UE determines that the re-selection of resources is triggered by reaching a maximum number of reservations, the method iterates from the step 204. On the other hand, if the Tx UE determines that a resource re-selection is not triggered, the method may iterate from the step 214 for another transmission.

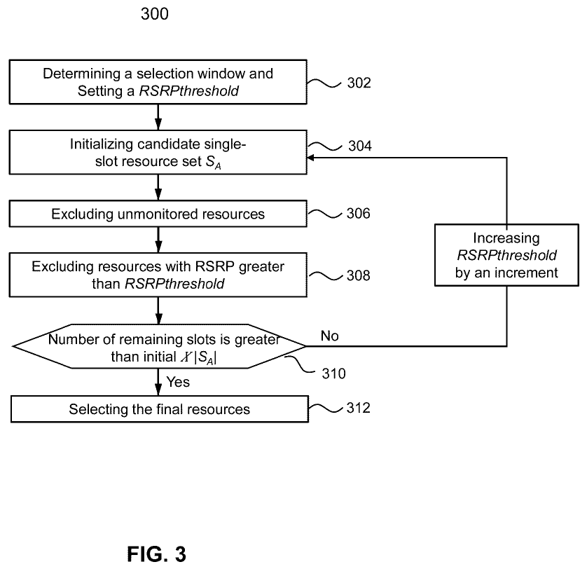

FIG. 3 is a schematic diagram illustrating a method 300 for determining a resource candidate set, consistent with some embodiments of the present disclosure. Referring to FIG. 3, the method 300 includes a step 302 of determining a selection window and setting a reference signal received power (RSRP) threshold (RSRPthreshold). For example, a Tx UE in a sidelink communication, such as the UE 102 of FIG. 1 may determine a selection window for resource selection and set an RSRPthreshold. For example, the Tx UE may perform a channel sensing first, and based on the channel sensing, determine a selection window T (e.g., T=[T₁, T₂], where T₁=<4 ms, and 20=<T₂=<100 ms). The selection of the T₁ and T₂ values depends on the UE implementation. The RSRPthreshold may be configured by a network node (e.g., the base station 106 of FIG. 1) or pre-configured at the Tx UE.

The method 300 includes a step 304 of initializing candidate single-slot resource set S_{A}. For example, the Tx UE may collect a set S_{A} of potential candidate resource slots that are within the defined selection window. The method 300 includes a step 306 of excluding unmonitored resources. For example, the unmonitored resources are the resources that the Tx UE cannot sense due to its own transmission (i.e., half-duplex constraint) or other activities including discontinuous reception (DRX). For example, the Tx UE may exclude one or more slots from the single-slot resource set of S_{A}.

The method 300 includes a step 308 of excluding resources with RSRP greater than the RSRPthreshold. For example, the UE may further exclude resources occupied or reserved by other UEs from the selection window if a corresponding SL-RSRP exceeds a SL-RSRP threshold.

The method 300 includes a step 310 of determining whether the number of remaining slots is greater than initial X*|S_{A}|. For example, the Tx UE determines whether the number of candidate resources is greater than X % of the total number of resources in the selection window. For example, if the Tx UE determines that the number of candidate resources is not greater than X % of the total number of resources in the selection window, at a step 311 the Tx UE increases the SL-RSRP threshold by an increment (and the method 300 iterates at step 302), until at least X % resources are obtained. The increment can be 3 dB or any other value(s). For example, the value X may be configured or preconfigured from {0.2, 0.35, 0.5}. On the other hand, if the Tx UE determines that the number of candidate resources is greater than X % of the total number of resources in the selection window, the method may proceed with a step 312 of selecting the final resources.

The method 200 includes the step 312 of selecting final resources. For example, if the number of remaining single slot candidates are greater than X*|S_{A}| (where X=0.2, 0.35, 0.5), the Tx UE forwards the potential candidate slots to higher layers (e.g., medium access control (MAC) layer) for final resource selection.

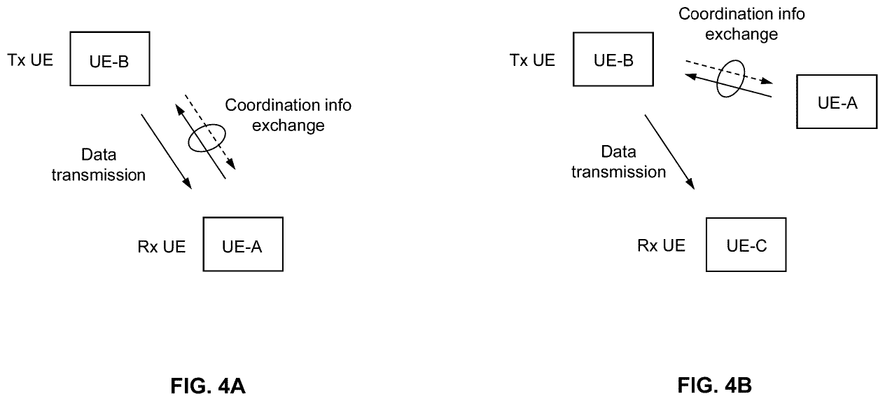

FIG. 4A is a schematic diagram illustrating a first inter-UE coordination scheme; and FIG. 4B is a schematic diagram illustrating a second inter-UE coordination scheme, consistent with some embodiments of the present disclosure. The above-discussed method 200 may support IUC in which a UE-A sends coordination information about resources to a UE-B, and the UE-B utilizes that information for its resource selection or reselection.

Referring to FIG. 4A, a sidelink communication system includes a UE-A and a UE-B that communicate with each other. The UE-B may be a Tx UE (such as the UE 102 of FIG. 1) and the UE-A may be an Rx UE (such as the UE 104 of FIG. 1) so that UE-B may transmit data to the UE-A. In the first IUC scheme, as shown in FIG. 4A, a coordination information exchange is triggered between the UE-A and the UE-B. The coordination information provided from the UE-A to the UE-B may include indications of resources that are preferred to be included in UE-B's selected or re-selected resources, or preferred to be excluded. In an embodiment, when an indication of resources indicates resources that are preferred to be included, the UE-B may solely rely on those resources, if the UE-B does not support sensing and/or resource exclusion. In an embodiment, the UE-B may also combine the indication of resources with resources identified by its own sensing procedure before making a final selection. In an embodiment, the UE-B does not take into account the indication received from the UE-A in resource selection (or re-selection). The indication from the UE-A to the UE-B may be sent in MAC control element (CE) and/or 2nd-stage SCI.

Referring to FIG. 4B, a sidelink communication system includes a UE-A, a UE-B, and a UE-C. The UE-B may be a Tx UE (such as the UE 102 of FIG. 1) in a sidelink communication, and the UE-C may be an Rx UE (such as the UE 104 of FIG. 1) in the sidelink communication so that UE-B may transmit data to the UE-C. In the second IUC scheme, as shown in FIG. 4B, a coordination information exchange is triggered between the UE-B and the UE-A, and the UE-A provides, to the UE-B, an indication that resources reserved for the UE-B's transmission will be, or could be, subject to conflict with a transmission from other UEs. The UE-B's transmission may or may not be to the UE-A. In this case, the UE-B may re-select new resources. The indication from the UE-A to the UE-B may be sent in PSFCH.

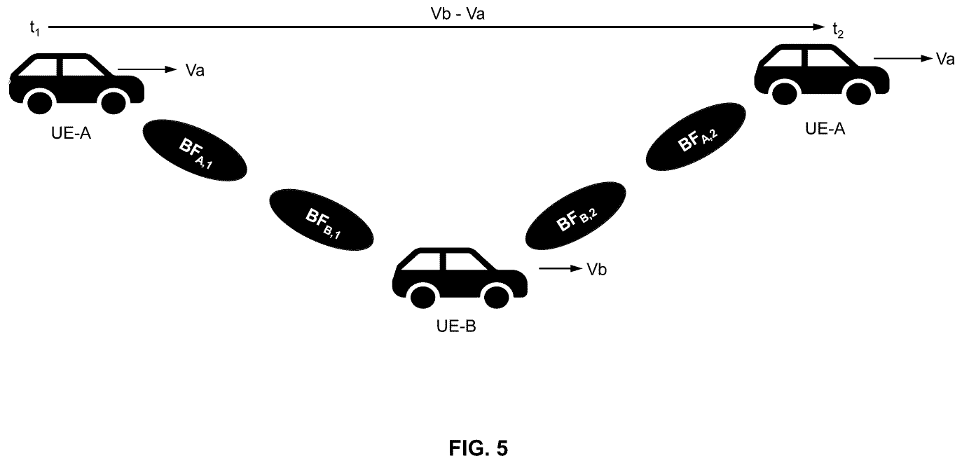

FIG. 5 is a schematic diagram illustrating a movement of a Tx UE relative to an Rx UE in a sidelink communication, consistent with some embodiments of the present disclosure. Referring to FIG. 5, a sidelink communication system includes a UE-A and a UE-B that communicate with each other. The UE-A may be a Tx UE (such as the UE 102 of FIG. 1) and the UE-B may be an Rx UE (such as the UE 104 of FIG. 1) so that UE-A may transmit data to the UE-B. The speed of the UE-A (Va) is higher than the speed of UE-B so that the UE-A is moving relative to the UE-B. For example, the movement of the UE-A relative to the UE-B from t1 (an initial time) to t2 (an end time) is (Vb−Va), as shown in FIG. 5. The UE-B and the UE-A may communicate at high frequency signal bands (e.g., FR2). In the present disclosure, FR2 is defined as two frequency sub-ranges: FR2-1 from 24250 to 52600 MHz and FR2-2 from 52600 to 71000 MHz (including the millimeter wave spectrum). In this case, the UE-A and the UE-B apply a spatial filter so that they can concentrate energy transmitted or received from their antenna elements in the spatial domain so as to create a transmitting or receiving spatial filter in a particular direction. As shown in FIG. 5, as the UE-A (the Tx UE) moves in reference to UE-B (the Rx UE), their respective Tx and Rx spatial filters are adjusted so as to keep beam alignment (e.g., BF_{A,1} and BF_{B,1}; BF_{A,2} and BF_{B,2}) between the UE-A and the UE-B. In some embodiments, since the sidelink communications at high frequency bands are directional, the channel sensing procedure also takes spatial directionality into account. For example, an Rx spatial filter is applied at the UE performing the sensing procedure.

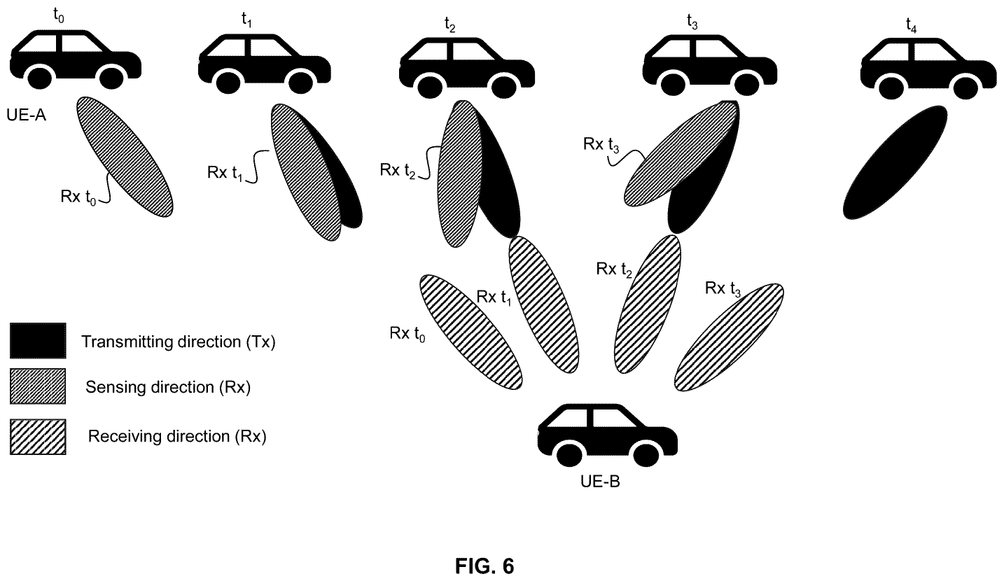

FIG. 6 is a schematic diagram illustrating a channel sensing method in a sidelink communication, consistent with some embodiments of the present disclosure. Referring to FIG. 6, a sidelink communication system includes a UE-A and a UE-B that communicate with each other. The UE-A may be a Tx UE (such as the UE 102 of FIG. 1) and the UE-B may be an Rx UE (such as the UE 104 of FIG. 1) so that UE-A may transmit data to the UE-B. The speed of the UE-A is higher than the speed of UE-B so that the UE-A is moving relative to the UE-B. The UE-B and the UE-A may communicate at high frequency bands (e.g., FR2). In some embodiments, the UE-A may perform periodic transmissions to the UE-B, for example, at t1, t2, t3, and t4 (t1 is a time later than the initial time t0, t2 is a time later than t1, t3 is a time later than t2, t4 is a time later than t3). At time instance t0, when performing channel sensing, the UE-A directs its Rx spatial filter in the direction where it will be transmitting at t1. At time instance t1, when performing channel sensing, the UE-A directs the Rx spatial filter in the direction where it will be transmitting at t2. At time instance t2, when performing channel sensing, the UE-A directs the Rx spatial filter in the direction where it will be transmitting at t3. At time instance t3, when performing channel sensing, the UE-A directs the Rx spatial filter in the direction where it will be transmitting at t4. A similar procedure will be repeated for the UE-B's channel sensing.

In this way, when performing channel sensing procedure, the UE-A selects the direction of its Rx spatial filter such that it matches the spatial direction where it expects to perform a transmission, so that the beam alignment between the UE-A and the UE-B is ensured when the UE-A performs the transmission.

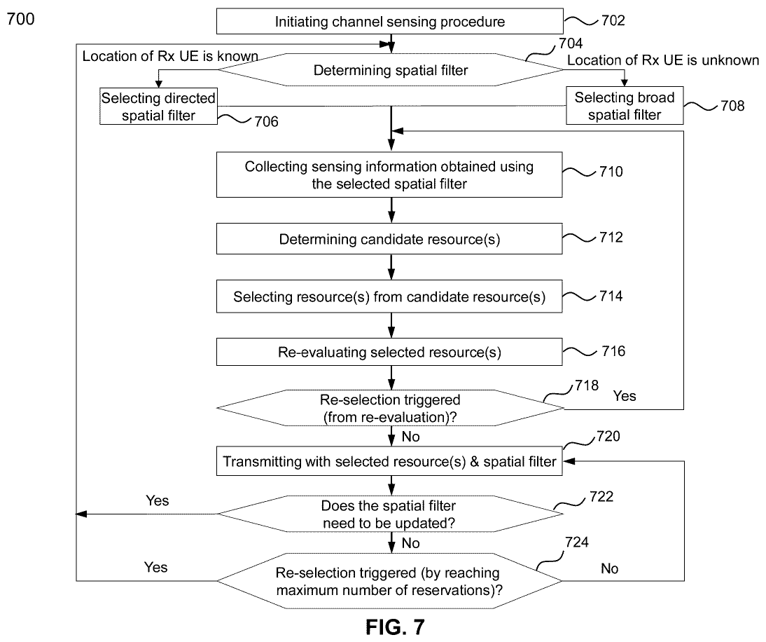

FIG. 7 is a schematic diagram illustrating a method 700 for resource selection in a sidelink communication, consistent with some embodiments of the present disclosure. Referring to FIG. 7, the method 700 includes a step 702 of performing a channel sensing (e.g., background sensing or any other type of full sensing or partial sensing). For example, a Tx UE in a sidelink communication, such as the UE 102 of FIG. 1 or the UE-A of FIG. 6 initiates a channel sensing. Before initiation of the channel sensing, the UE may or may not know that it has a transmission to perform. For example, the Tx UE may perform a channel sensing in a sensing window (e.g., 100 ms or 1100 ms).

The method 700 may include a step 704 of determining a spatial filter configuration. For example, in an embodiment, the Tx UE may determine a spatial filter configuration based on location information of a targeted Rx UE. In this embodiment, the Tx UE may determine whether the location of a targeted Rx UE is known to the Tx UE. For example, the location of the target Rx UE may be known to the Tx UE based on a reception of a cooperative awareness message (CAM) or a basic safety message (BSM) transmitted from the targeted Rx UE. The CAM or BSM may be broadcast periodically from the targeted Rx UE.

In an embodiment, if the Tx UE determines that the location of the target Rx UE is known to the Tx UE, the method 700 proceeds with a step 706 of selecting a directed spatial filter configuration. On the other hand, if the Tx UE determines that the location of the targeted Rx UE is unknown to the Tx UE, the method 700 proceeds with a step 708 of selecting a broader spatial filter configuration.

The method 700 includes a step 710 of collecting sensing information obtained using the spatial filter configuration. The sensing information may include at least one of: sidelink resource reservation information, or at least one SL-RSRP measurement of the sidelink communication. For example, the Tx UE may perform channel sensing in the sensing window and collect another UE's resource reservation information based on SCI decoding to identify candidate resources. The UE may decode the SCI using two stages: a first stage SCI (SCI format 1-A) and a second stage SCI (SCI format 2-A or 2-B) as defined in the 3GPP specification.

The method 700 includes a step 712 of determining one or more candidate resources. For example, the Tx UE may determine one or more candidate resources based on the sensing information. The Tx UE may determine a candidate resource set, for example, using the method for determining candidate resource set as described with respect to FIG. 3.

The method 700 includes a step 714 of selecting one or more resources from the one or more candidate resources for transmission. In an embodiment, the Tx UE may select one or more resources semi-persistently. In another embodiment, the Tx UE may select one or more resources up to a maximum number of resource reservations. The selection may be a random selection.

The method 700 includes a step 716 of re-evaluating the selected one or more resources. For example, the Tx UE may re-evaluate, using the selected spatial filter configuration, the selected one or more resources. In an embodiment, the Tx UE may re-evaluate the selected one or more resources by decoding one or more signals on a PSCCH received from one or more other UEs, in which the PSCCH is received using the selected spatial filter configuration. In another embodiment, the Tx UE may re-evaluate the selected one or more resources by measuring one or more SL-RSRP on at least one of PSCCH or PSSCH received from the one or more other UEs, in which the at least one of PSCCH or PSSCH is received using the selected spatial filter configuration. In another embodiment, the Tx UE may re-evaluate the selected one or more resources by combining the decoding of the one or more signals on a PSCCH and measuring one or more SL-RSRP on at least one of PSCCH or PSSCH.

The method 700 includes a step 718 of determining, based on a result of the re-evaluating of the selected one or more resources, whether a re-selection of the one or more resources is triggered. For example, if the Tx UE determines that a resource re-selection is triggered, the method may iterate from the step 710. On the other hand, if the Tx UE determines that a resource re-selection is not triggered, the method may proceed with a step 720 of transmitting using the selected one or more resources and the spatial filter configuration. For example, in response to a determination that the re-selection of the one or more resources is not triggered, the Tx UE may transmit a signal or data based on the selected spatial filter configuration and the one or more selected resources.

The method 700 may include a step 722 of determining whether the spatial filter needs to be updated. For example, after transmitting a signal or data using the selected spatial filter configuration and the one or more selected resources, the Tx UE may determine whether to update the spatial filter configuration. If the Tx UE determines that the spatial filter configuration needs to be updated, the method iterates from the step 704 so that the Tx UE can select a new spatial filter configuration to replace the spatial filter configuration.

On the other hand, if the Tx UE determines that the spatial filter configuration does not need to be updated, the method 700 proceeds with a step 724 of determining whether re-selection is triggered by reaching a maximum number of reservations. For example, if the Tx UE determines that the re-selection of the one or more resources is triggered, the method 700 iterates from the step 704 of determining the spatial filter configuration so that the Tx UE can select a new spatial filter configuration to replace the spatial filter configuration. On the other hand, if the Tx UE determines that the second re-selection of resources is not triggered, the method 700 initiates from 720 to initiate another transmission using the spatial filter configuration.

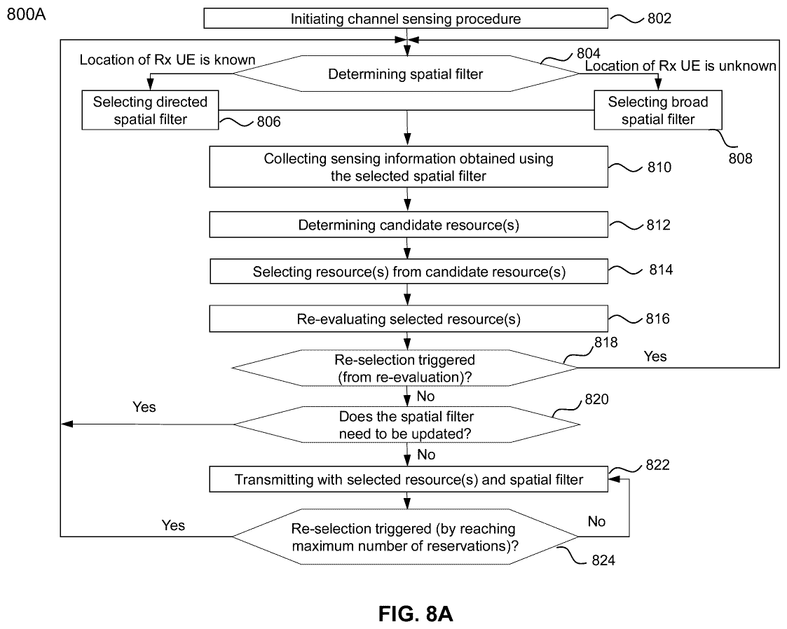

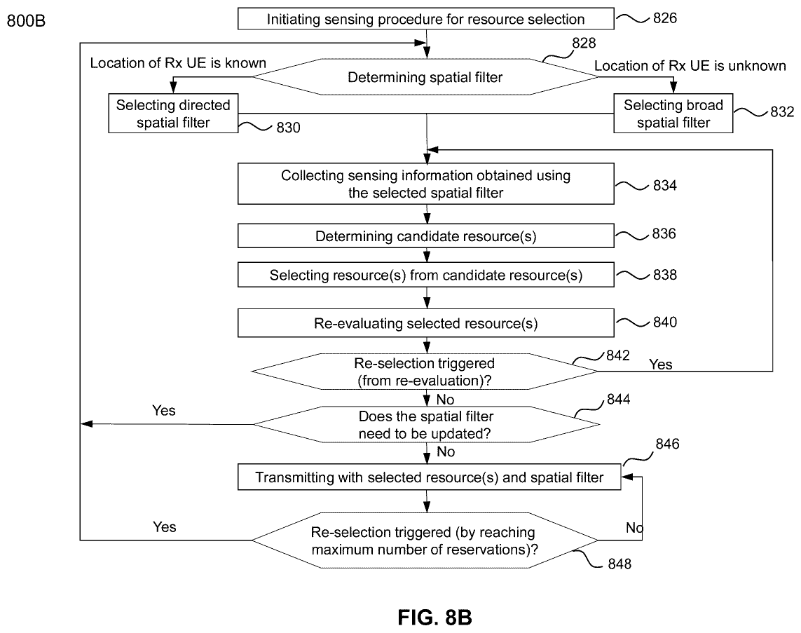

FIG. 8A is a schematic diagram illustrating a method 800A for resource selection in a sidelink communication, consistent with some embodiments of the present disclosure.

The method 800A may be performed by a Tx UE in a sidelink communication, such as the UE 102 of FIG. 1 or the UE-A of FIG. 6. Referring to FIG. 8A, the method 800A includes steps 802, 804, 806, 808, 810, 812, 814, and 816 that correspond to the steps 702, 704, 706, 708, 710, 712, 714, and 716, respectively. For the sake of brevity, the descriptions of the steps 802-816 are omitted here.

The method 800A may include a step 818 of determining, based on a result of the re-evaluating of the selected one or more resources, whether a re-selection of the one or more resources is triggered. For example, if the Tx UE determines that a resource re-selection is triggered, the method 800A may iterate from the step 804 of determining spatial filter configuration. On the other hand, if the Tx UE determines that a resource re-selection is not triggered, the method 800A may proceed with a step 820 of determining whether the spatial filter needs to be updated. If the Tx UE determines that the spatial filter configuration needs to be updated, the method iterates from the step 804 so that the Tx UE can select a new spatial filter configuration to replace the spatial filter configuration. On the other hand, if the Tx UE determines that the spatial filter configuration does not need to be updated, the method 800A proceeds with a step 822 of transmitting using the selected one or more resources and the spatial filter configuration.

The method 800A may include a step 824 of determining whether re-selection is triggered by reaching a maximum number of reservations. In response to a determination that the re-selection of the one or more resources is not triggered, the method 800A may iterate from the step 822 so that the Tx UE may transmit a signal or data based on the selected spatial filter configuration and the one or more selected resources. On the other hand, if the Tx UE determines that the re-selection of the one or more resources is triggered, the method 800A iterates from the step 804 of determining the spatial filter configuration so that the Tx UE can select a new spatial filter configuration to replace the spatial filter configuration.

FIG. 8B is a schematic diagram illustrating a method 800B for resource selection in a sidelink communication, consistent with some embodiments of the present disclosure. The method 800B may be performed by a Tx UE in a sidelink communication, such as the UE 102 of FIG. 1 or the UE-A of FIG. 6. Referring to FIG. 8B, the method 800B includes steps 826, 828, 830, 832, 834, 836, 838, 840, 844, 846, and 848 that correspond to the steps 802, 804, 806, 808, 810, 812, 814, 816, 820, 822, and 824, respectively. For the sake of brevity, the descriptions of the steps 826, 828, 830, 832, 834, 836, 838, 840, 844, 846, and 848 are omitted here. The method 800B is similar to the method 800A of FIG. 8A, except that a step 842 is different from the corresponding step (818) of the method 800A.

The method 800B may include the step 842 of determining, based on a result of the re-evaluating of the selected one or more resources, whether a re-selection of the one or more resources is triggered. If the Tx UE determines that a resource re-selection is triggered, the method 800B may iterate from the step 834 of collecting sensing information (rather than determining spatial filter configuration in the method 800A). On the other hand, if the Tx UE determines that a resource re-selection is not triggered, the method 800B may proceed with a step 844 of determining whether the spatial filter needs to be updated (which corresponds to the step 820 of the method 800A).

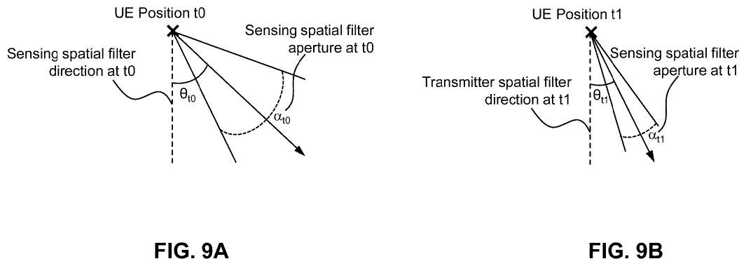

FIG. 9A is a schematic diagram illustrating a spatial filter configuration applied for channel sensing at a first time instance; and FIG. 9B is a schematic diagram illustrating a spatial filter configuration applied for channel sensing at a second time instance, consistent with some embodiments of the present disclosure. Referring to FIG. 9A, at a time t0, a spatial filter having direction (angle) θₜ₀, and aperture αₜ₀ is applied for channel sensing. Referring to FIG. 9B, at a time t1 (t1 is a time later than to), a spatial filter having direction (angle) θₜ₁, and aperture αₜ₁ is applied for channel sensing. In some embodiments, the selection of the Rx spatial filter (direction and aperture) to apply in the channel sensing at to is not only based on the direction of the transmission at t1, but also a function of the UE's position at t1. As shown in FIGS. 9A and 9B, the direction (θₜ₀) and aperture (αₜ₀) of the sensing spatial filter at t0, covers the direction (θₜ₁) and aperture (αₜ₁) of the transmitting spatial filter at t1. In some embodiments, the RSRP thresholds that are used to identify free resources during the channel sensing procedure, for example, as discussed in FIGS. 2, 7, and 8A-8B, may be adapted to compensate between the difference in spatial filter gain at t0 and t1. The relation between the spatial filter parameters and initial RSRP thresholds at t0 and t1 can be given as:

$${θ}_{t 0} = {f}_{θ} ( {θ}_{t 1} , {t}_{0} , {t}_{1} , {v}_{tx} , {v}_{rx} ) \qquad [ Math 1 ]$$

$${α}_{t 0} = {f}_{α} ( {α}_{t 1} , {t}_{0} , {t}_{1} , {v}_{tx} , {v}_{rx} )$$

$${RSRPthr}_{t 0} = {f}_{RSRPthr} ( {RSRPthr}_{t 1} , {t}_{0} , {t}_{1} , {v}_{tx} , {v}_{rx} )$$

where vₜₓ is a speed of a Tx UE, and vᵣₓ is a speed of an Rx UE. The functions above account for the movement of the Tx UE and Rx UE; and therefore allow the Tx UE to select the appropriate values for the aperture, direction and initial RSRP threshold to apply.

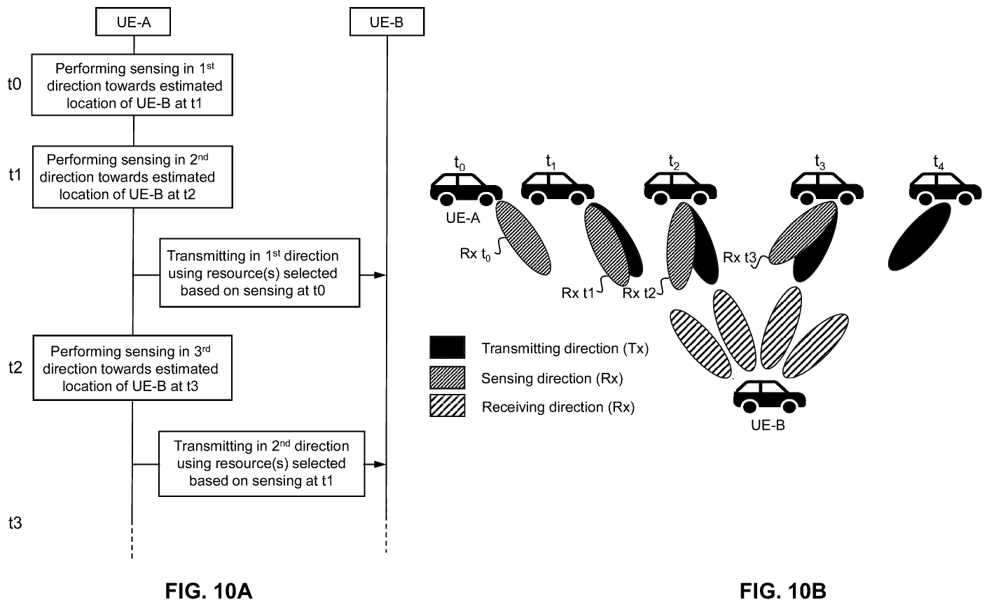

FIG. 10A is a schematic diagram illustrating a method for channel sensing in a sidelink communication; and FIG. 10B is a schematic diagram illustrating a spatial filter adjustment over time, consistent with some embodiments of the present disclosure. Referring to FIG. 10A and FIG. 10B, a sidelink communication includes a UE-A (a Tx UE) and a UE-B (an Rx UE).

As shown in FIG. 10A and FIG. 10B, at time t0, the UE-A performs a first sidelink sensing in a first direction towards an estimated location of UE-B at t1 (t1 is a time later than to). At time t1, the UE-A performs a second sidelink sensing in a second direction towards an estimated location of UE-B at t2 (t2 is a time later than t1). Thereafter, during the time period starting at t1 and ending at t2, the UE-A transmits a signal or data in the first direction towards the estimated location of the second UE at t1, using at least one resource selected based on the first sidelink sensing performed at t0. During the time period starting at t0 and ending at t2 (a first time period), the UE-A applies a first spatial filter configuration.

Thereafter, at time t2, the UE-A performs a third sidelink sensing in a third direction towards an estimated location of the second UE at t3 (t3 is a time later than t2). Thereafter, during the time period starting at t2 and ending at t3 (a second time period), the UE-A transmits a signal or data in the second direction towards the estimated location of the second UE at t2, using at least one resource selected based on the first sidelink sensing performed at t1. During the second time period, the UE-A applies a second spatial filter configuration that may be different from the first spatial filter configuration. The above noted process may be repeated.

In some embodiments, the UE-A performs the first sidelink sensing and the second sidelink sensing when a difference between t1 and to is greater than a minimum difference and smaller than a maximum difference. The minimum difference and/or the maximum difference may be pre-configured at the UE-A or configured by a network node (e.g., the base station 106 of FIG. 1). In some embodiments, the minimum difference and/or the maximum difference is a function of an absolute speed of the UE-A and a relative speed of the UE-A relative to the UE-B.

In some embodiments, the UE-A performs the first sidelink sensing and the second sidelink sensing only when the first spatial filter configuration is expected to be changed to the second spatial filter configuration in the time period starting at t2 and ending at t3. In some embodiments, the UE-A may adapt (adjust) one or more RSRP thresholds used during the first sidelink sensing and the second sidelink sensing at t0 and t1. In some embodiments, the UE-A may adapt (adjust) one or more RSRP thresholds used during the first sidelink sensing and the second sidelink sensing based on a spatial filter gain difference.

In some embodiments, the sidelink sensing in the second direction towards the estimated location of the UE-B at t2 may be performed before transmission of the signal or data in the first direction towards the estimated location of the UE-B at t1. The SCI at the transmission indicates one or more resources to be used at t2. The UE-A may further monitor a resource pool while adapting the first spatial filter configuration, and determine whether a re-selection of the one or more resources is triggered.

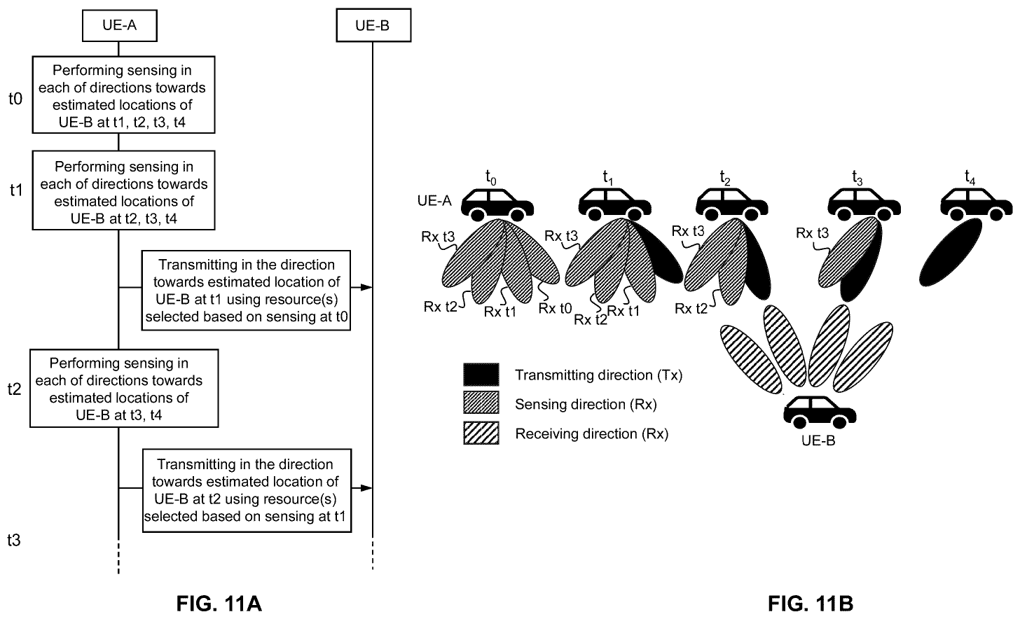

FIG. 11A is a schematic diagram illustrating a method for channel sensing in a sidelink communication; and FIG. 11B is a schematic diagram illustrating a spatial filter adjustment over time, consistent with some embodiments of the present disclosure. Referring to FIG. 11A and FIG. 11B, a sidelink communication includes a UE-A (a Tx UE) and a UE-B (an Rx UE). In this method, the UE-A performs the sensing in the directions of multiple future transmission instants within a time interval.

As shown in FIGS. 11A and 11B, at time t0, the UE-A performs a first sidelink sensing in each of directions towards estimated locations of the UE-B at a plurality of time instances after to including t1, t2, t3, and t4 (t1 is a time later than to, t2 is a time later than t1, t3 is a time later than t2, and t4 is a time later than t3). At time t1, the UE-A performs a second sidelink sensing in each of the directions towards estimated locations of the second UE at the plurality of time instances after t1 including t2, t3, and t4. During the time period starting at t1 and ending at t2, the UE-A transmits a signal or data in the first direction towards the estimated location of UE-B at t1, using at least one resource selected based on the first sidelink sensing performed at t0. During the time period starting at t0 and ending at t2 (a first time period), the UE-A applies a first spatial filter configuration.

Thereafter, at time t2, the UE-A performs a third sidelink sensing in each of the directions towards the estimated locations of the UE-B at the plurality of time instances after t2 including t3 and t4. During the time period starting at t2 and ending at t3 (a second time period), the UE-A transmits a signal or data in the direction towards the estimated location of the UE-B at t2, based on at least one resource determined by the second sidelink sensing performed at t1. During the second time period, the UE-A applies a second spatial filter configuration that may be different from the first spatial filter configuration. The above noted process may be repeated.

In some embodiments, one or more RSRP thresholds used during the first sidelink sensing and the second sidelink sensing are adapted at t0 and t1. In some embodiments, during performing the first sidelink sensing in each of directions towards to the estimated locations of the UE-B at t1, t2, t3, and t4, the UE-A may use a different RSRP threshold for each of the directions toward to the estimated locations of the second UE at t1, t2, t3, and t4.

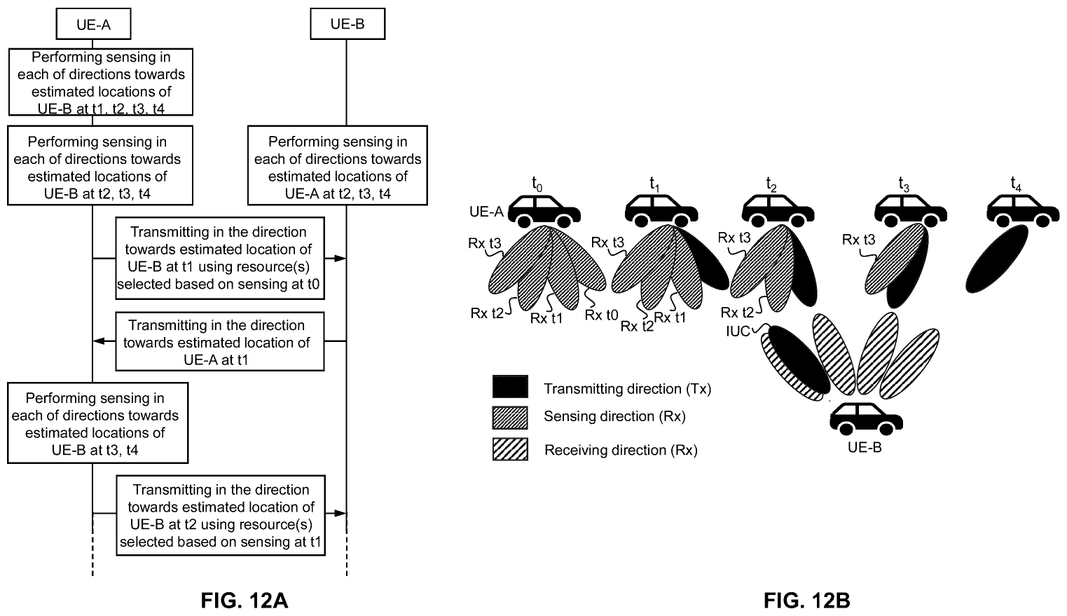

FIG. 12A is a schematic diagram illustrating a method for channel sensing in a sidelink communication; and FIG. 12B is a schematic diagram illustrating a spatial filter adjustment over time, consistent with some embodiments of the present disclosure. Referring to FIG. 12A and FIG. 12B, a sidelink communication includes a UE-A (a Tx UE) and a UE-B (an Rx UE). The method shown in FIGS. 12A-12B is essentially the same as the method shown in FIGS. 11A-11B, except that in the method of FIGS. 12A-12B, the UE-B also performs channel sensing and provides an IUC signal to the UE-A by a transmission to the UE-A. The UE-A may consider the IUC information received from the UE-B in performing resource selection. For the sake of brevity, the details of the method of FIGS. 12A-12B that are similar to the method of FIGS. 11A-11B are omitted here.

As shown in FIG. 12A and FIG. 12B, the UE-A receives, from the UE-B, the IUC signal. The IUC signal may include information of a sidelink sensing performed by the UE-B at t1 in each of directions towards estimated locations of the UE-A at the plurality of time instances after t1 including t2, t3, and t4. In an embodiment, during the second time period, the UE-A may transmit a signal or data in the direction toward the estimated location of the UE-B, based on at least one resource determined based on the IUC signal received from the UE-B. In another embodiment, during the second time period, the UE-A may transmit a signal or data in the direction toward the estimated location of the UE-B, based on at least one resource determined based on the sidelink sensing performed by the UE-B at t1 and the IUC signal received from the UE-B.

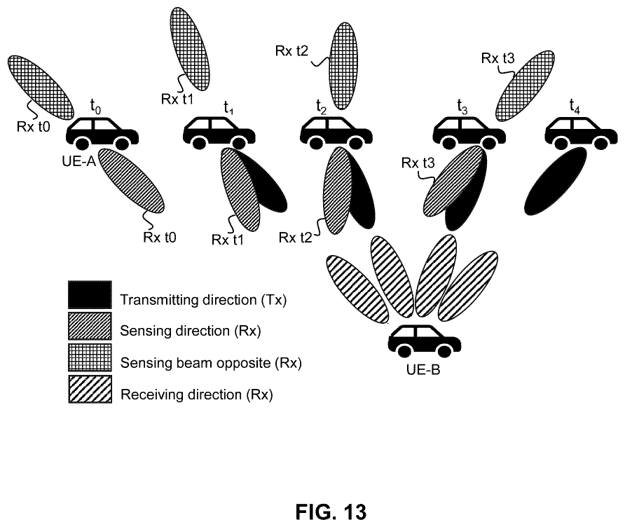

FIG. 13 is a schematic diagram illustrating a method for channel sensing in a sidelink communication, consistent with some embodiments of the present disclosure. Referring to FIG. 13, a sidelink communication includes a UE-A (a Tx UE) and a UE-B (an Rx UE). The method of FIG. 13 is essentially the same as the method of FIGS. 10A-10B, except that in the method of FIG. 13, the UE-A directs its spatial filter, when performing sensing, in the direction where it be transmitting at t1 as well as in the opposite direction as shown in FIG. 13. When the UE-A is performing sensing at t1, it directs the spatial filter in the direction where it will be transmitting at t2 as well as in the opposite direction. For the sake of brevity, the details of the method of FIG. 13 similar to that of the method of FIGS. 10A-10B are omitted here.

Referring to FIG. 13, at time t0, the UE-A performs a first sidelink sensing in a first direction towards an estimated location of UE-B at t1 (t1 is a time later than to), and a sidelink sensing in a direction opposite to the first direction. At time t1, the UE-A performs a second sidelink sensing in a second direction towards an estimated location of UE-B at t2 (t2 is a time later than t1), and a sidelink sensing in a direction opposite to the second direction. Thereafter, at time t2, the UE-A performs a third sidelink sensing in a third direction towards an estimated location of the second UE at t3 (t3 is a time later than t2), a sidelink sensing in a direction opposite to the third direction.

In this way, UE-A may detect other UEs' signals coming from the opposite direction of the Tx beam of the UE-A at t1 (or t2 or t3) that may interfere with UE-A's signal at UE-B's reception. The UE-A may then avoid using resources having the same time and/or frequency as these interfering signals, thereby minimizing interference at the UE-B's reception.

The methods described in this disclosure can be applied to any sidelink communications, for example, long term evolution (LTE) or new radio (NR) or a future generation (6^{th} generation (6G), 7^{th} generation (7G), or any future generation) sidelink communications. The methods described in this disclosure can also be applied to downlink/uplink communications between a base station and a UE. The methods described in this disclosure can also be applied to other systems, for example, the systems that comply with other standards (e.g., the Institute of Electrical and Electronics Engineers (IEEE) standards).

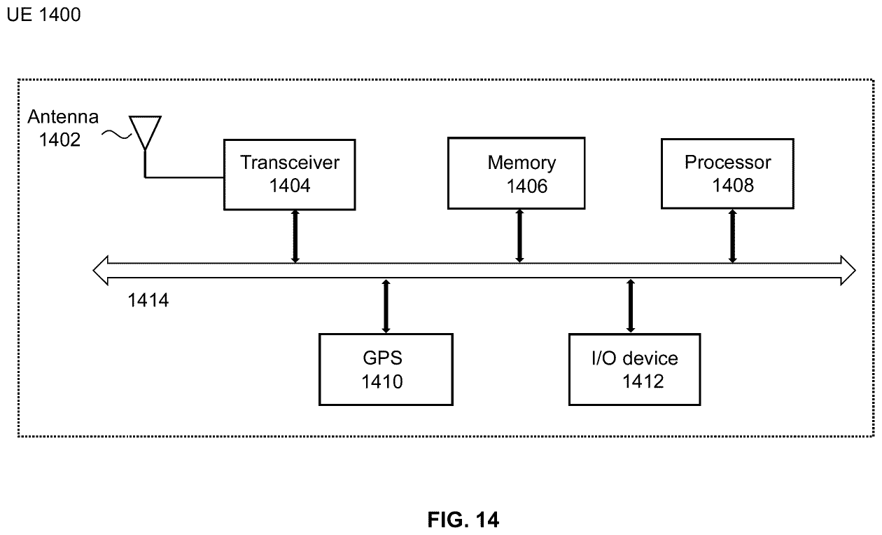

FIG. 14 is a block diagram of a UE 1400, consistent with some embodiments of the present disclosure. For example, each of the Tx UE and the Rx UE in FIGS. 1, 4A, 4B, 5, 10A, 10B, 11A, 11B, 12A, 12B, and 13 may be in the form of UE 1400. UE 1400 may be mounted in a moving vehicle or in a fixed position. UE 1400 may take any form, including but not limited to, a vehicle, a component mounted in a vehicle, a road-side unit, a laptop computer, a wireless terminal including a mobile phone, a wireless handheld device, or wireless personal device, or any other form. Referring to FIG. 14, the UE 1400 may include antenna 1402 that may be used for transmission or reception of electromagnetic signals to/from a base station or other UEs. The Antenna 1402 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 1402 may include multiple (e.g., tens or hundreds) antenna elements and may enable multi-antenna functions such as beamforming. In some embodiments, the antenna 1402 is a single antenna. The antenna 1402 can be an FR1 antenna or an FR2 antenna. The UE 1400 may include a transceiver 1404 that is coupled to the antenna 1402. The transceiver 1404 may be a wireless transceiver at the UE 1400 and may communicate bi-directionally with a base station or other UEs. For example, the transceiver 1404 may receive/transmit wireless signals from/to a base station via downlink/uplink communication. The transceiver 1404 may also receive/transmit wireless signals from/to another UE or road side unit via sidelink communication. The transceiver 1404 may include a modem to modulate the packets and provide the modulated packets to the antenna 1402 for transmission, and to demodulate packets received from the antenna 1402.

The UE 1400 may include a memory 1406. The memory 1406 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 1406 may store information related to identities of UE 1400 and the signals and/or data received by antenna 1402. The memory 1406 may also store post-processing signals and/or data. The memory 1406 may also store computer-readable program instructions, mathematical models, and algorithms that are used in signal processing in receiver 1404 and computations in processor 1408. The memory 1406 may further store computer-readable program instructions for execution by processor 1408 to operate UE 1400 to perform various functions described in this disclosure. In some examples, the memory 1406 may include a basic input/output system (BIOS) which may control basic hardware or software operation such as the interaction with peripheral components or devices. In some embodiments, the memory 1406 includes both LTE SL and NR SL modules. In some embodiments, the memory 1406 includes an NR SL module only. In some embodiments, the memory 1406 includes an LTE SL module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 1400 may include a processor 1408 that may include a hardware device with processing capabilities. The processor 1408 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 1408 may be implemented using a combination of devices (e.g., a combination of a DSP and a microprocessor, multiple microprocessors, one or more microprocessors in conjunction with a DSP core, or any other such configuration). The processor 1408 may receive, from transceiver 1404, downlink signals or sidelink signals and further process the signals. The processor 1408 may also receive, from transceiver 1404, data packets and further process the packets. In some embodiments, the processor 1408 may be configured to operate a memory using a memory controller. In some embodiments, a memory controller may be integrated into the processor 1408. The processor 1408 may be configured to execute computer-readable instructions stored in a memory (e.g., the memory 1406) to cause the UE 1400 to perform various functions. The UE 1400 may include a global positioning system (GPS) 1410. The GPS 1410 may be used for enabling location-based services or other services based on a geographical position of the UE 1400 and/or synchronization among UEs. The GPS 1410 may receive global navigation satellite systems (GNSS) signals from a single satellite or a plurality of satellite signals via the antenna 1402 and provide a geographical position of the UE 1400 (e.g., coordinates of the UE 1400). In some embodiments, the GPS 1410 is omitted. In some embodiments, a timer is included.

The UE 1400 may include an input/output (I/O) device 1412 that may be used to communicate a result of signal processing and computation to a user or another device. The I/O device 1412 may include a user interface including a display and an input device to transmit a user command to processor 1408. The display may be configured to display a status of signal reception at the UE 1400, the data stored at memory 1406, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 1400 may further include a machine interface 1414, such as an electrical bus that connects the transceiver 1404, the memory 1406, the processor 1408, the GPS 1410, and the I/O device 1412.

In some embodiments, the UE 1400 may be a Tx UE in a sidelink communication. The processor 1408 may be configured or programmed to execute the instructions stored in the memory 1406 to determine a spatial filter configuration, the spatial filter configuration being associated with a first time period; collect sensing information obtained using the spatial filter configuration, the sensing information including at least one of: sidelink resource reservation information, or at least one SL-RSRP measurement of the sidelink communication; determine one or more candidate resources based on the sensing information; select one or more resources from the one or more candidate resources for transmission; re-evaluate, using the spatial filter configuration, the selected one or more resources; and determine, based on a result of the re-evaluating of the selected one or more resources, whether a re-selection of the one or more resources is triggered.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives. Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1. A method for resource selection in a sidelink communication, the method comprising:
determining, by a user equipment (UE), a spatial filter configuration, the spatial filter configuration being associated with a first time period;
collecting, by the UE, sensing information obtained using the spatial filter configuration, the sensing information including at least one of: sidelink resource reservation information, or at least one sidelink reference signal received power (SL-RSRP) measurement of the sidelink communication;
determining, by the UE, one or more candidate resources based on the sensing information;
selecting, by the UE, one or more resources from the one or more candidate resources for transmission;
re-evaluating, by the UE, using the spatial filter configuration, the selected one or more resources; and
determining, based on a result of the re-evaluating of the selected one or more resources, whether a re-selection of the one or more resources is triggered.

Clause 2. The method of clause 1, wherein the UE is a first UE, and the method further comprises:
determining, by the first UE, whether a location of a second UE is known to the first UE.

Clause 3. The method of clause 2, further comprising:
selecting a directed spatial filter configuration as the spatial filter configuration, in response to a determination that the location of the second UE is known to the first UE.

Clause 4. The method of clause 2, further comprising:
selecting a broader spatial filter configuration as the spatial filter configuration, in response to a determination that the location of the second UE is unknown to the first UE.

Clause 5. The method of clause 1, wherein selecting the one or more resources from the one or more candidate resources further comprises:
selecting, by the UE, the one or more resources from the one or more candidate resources semi-persistently.

Clause 6. The method of clause 1, wherein selecting the one or more resources from the one or more candidate resources further comprises:
selecting, by the UE, the one or more resources from the one or more candidate resources up to a maximum number of one or more resource reservations.

Clause 7. The method of clause 1, further comprising: transmitting a signal or data based on the spatial filter configuration and the one or more selected resources, in response to a determination that the re-selection of the one or more resources is not triggered.

Clause 8. The method of clause 7, further comprising: determining, after the transmitting, whether to update the spatial filter configuration.

Clause 9. The method of clause 8, wherein the re-selection of the one or more resources is a first re-selection, and the method further comprises:
determining, based on a determination of whether a maximum number of one or more resource reservations is reached, whether a second re-selection of the one or more resources is triggered, in response to a determination that the first spatial filter configuration does not need to be updated.

Clause 10. The method of clause 9, further comprising: iterating the method from determining the spatial filter configuration, in response to a determination that the second re-selection of the one or more resources is triggered; and
initiating another transmission based on the spatial filter configuration, in response to a determination that the second re-selection of resources is not triggered.

Clause 11. The method of clause 9, further comprising: iterating the method from determining the spatial filter configuration, in response to a determination that the first spatial filter configuration needs to be updated.

Clause 12. The method of clause 7, further comprising: iterating the method from collecting the sensing information, in response to a determination that the re-selection of the one or more resources is triggered.

Clause 13. The method of clause 1, wherein the re-evaluating the selected one or more resources further comprises at least one of:
decoding one or more signals on a physical sidelink control channel (PSCCH) received from one or more other UEs, the PSCCH being received using the spatial filter configuration; or
measuring one or more sidelink reference signal received powers (SL-RSRP) on at least one of the PSCCH or physical sidelink shared channel (PSSCH) received from the one or more other UEs, the at least one of the PSCCH or the PSSCH being received using the spatial filter configuration.

Clause 14. The method of clause 1, further comprising: determining whether to update the spatial filter configuration, in response to a determination that the re-selection of the one or more resources is not triggered; and
in response to a determination that the re-selection of the one or more resources is triggered, iterating the method from determining the spatial filter configuration or from collecting the sensing information.

Clause 15. The method of clause 14, further comprising: transmitting a signal or data based on the spatial filter configuration, in response to a determination that the spatial filter configuration does not need to be updated.

Clause 16. The method of clause 15, wherein the re-selection of the one or more resources is a first re-selection, and the method further comprises: determining, based on a determination of whether a maximum number of resource reservations is reached, whether a second re-selection of the one or more resources is triggered.

Clause 17. The method of clause 16, further comprising: iterating the method from determining the spatial filter configuration, in response to a determination that the second re-selection of the one or more resources is triggered; and
initiating another transmission based on the spatial filter configuration, in response to a determination that the second re-selection of resources is not triggered.

Clause 18. The method of clause 14, further comprising: iterating the method from determining the spatial filter configuration, in response to a determination that the spatial filter configuration needs to be updated.

Clause 19. The method of clause 18, further comprising: selecting a new spatial filter configuration to replace the spatial filter configuration.

Clause 20. The method of clause 1, wherein the UE is a first UE, and the spatial filter configuration is determined based on location information of a second UE.

Clause 21. The method of clause 3, wherein the location of the second UE is known to the first UE based on a reception of a cooperative awareness message (CAM) or a basic safety message (BSM) transmitted from the second UE.

Clause 22. The method of clause 1, wherein the UE is a first UE, the spatial filter configuration is a first spatial filter configuration, and the first time period is a time period starting at t0 and ending at t2, and wherein collecting the sensing information obtained using the spatial filter configuration comprises:
performing, at t0, a first sidelink sensing in a first direction towards an estimated location of a second UE at t1, t1 being a time between t0 and t2; and performing, at t1, a second sidelink sensing in a second direction towards an estimated location of the second UE at t2.

Clause 23. The method of clause 22, further comprising: transmitting, before t2, a signal or data in the first direction towards the estimated location of the second UE at t1, using at least one resource selected based on the first sidelink sensing performed at t0.

Clause 24. The method of clause 23, wherein a second spatial filter configuration is associated with a second time period that is a time period starting at t2 and ending at t3, and the method further comprises:
performing, at t2, a third sidelink sensing in a third direction towards an estimated location of the second UE at t3.

Clause 25. The method of clause 24, further comprising: transmitting, before t3, a signal or data in the second direction towards the second UE at t2, using at least one resource selected based on the second sidelink sensing performed at t1.

Clause 26. The method of clause 22, wherein the first sidelink sensing and the second sidelink sensing are performed when a difference between t1 and to is greater than a minimum difference and smaller than a maximum difference.

Clause 27. The method of clause 26, wherein at least one of the minimum difference or the maximum difference is a function of an absolute speed of the first UE and a relative speed of the first UE relative to the second UE.

Clause 28. The method of clause 26, wherein at least one of the minimum difference or the maximum difference is pre-configured or configured.

Clause 29. The method of clause 24, wherein the first sidelink sensing and the second sidelink sensing are performed only when the first spatial filter configuration is expected to be changed to the second spatial filter configuration in the second time period.

Clause 30. The method of clause 22, wherein one or more reference signal received power (RSRP) thresholds used during the first sidelink sensing and the second sidelink sensing are adapted at t0 and t1.

Clause 31. The method of clause 22, wherein one or more reference signal received power (RSRP) thresholds used during the first sidelink sensing and the second sidelink sensing are adapted based on a spatial filter gain difference.

Clause 32. The method of clause 23, wherein the second sidelink sensing in the second direction towards the estimated location of the second UE at t2 is performed before transmission of the signal or data in the first direction towards the estimated location of the second UE at t1, and wherein sidelink control information (SCI) at the transmission indicates one or more resources to be used at t2, and the method further comprises:
monitoring, by the first UE, a resource pool while adapting the first spatial filter configuration; and
determining, by the first UE, whether a re-selection of the one or more resources is triggered.

Clause 33. The method of clause 1, wherein the UE is a first UE, the spatial filter configuration is a first spatial filter configuration, the first time period is a time period starting at t0 and ending at t2, and wherein collecting the sensing information obtained using the spatial filter configuration comprises:
performing, at t0, a first sidelink sensing in each of directions towards estimated locations of a second UE at a plurality of time instances after to including t1, t2, t3, and t4, wherein t2 is a starting point of a second time period and t3 is an end point of the second time period; and
performing, at t1, a second sidelink sensing in each of the directions towards estimated locations of the second UE at a plurality of time instances after t1 including t2, t3, and t4.

Clause 34 The method of clause 33, further comprising:
transmitting, before t2, a signal or data to the second UE in the direction towards the estimated location of the second UE at t1, using at least one resource determined from the first sidelink sensing performed at t0.

Clause 35. The method of clause 34, further comprising:
performing, at t2, a third sidelink sensing in each of the directions towards the estimated locations of the second UE at a plurality of time instances after t2 including t3 and t4.

Clause 36. The method of clause 35, further comprising:
transmitting, before t3, a signal or data to the second UE in the direction towards the estimated location of the second UE at t2, based on at least one resource determined by the second sidelink sensing performed at t1.

Clause 37. The method of clause 33, further comprising:
receiving, from the second UE, an inter-UE coordination (IUC) signal, the IUC signal including information of a sidelink sensing performed by the second UE at t1 in each of directions towards estimated locations of the first UE at the plurality of time instances after t1 including t2, t3, and t4.

Clause 38. The method of clause 33, wherein one or more reference signal received power (RSRP) thresholds used during the first sidelink sensing and the second sidelink sensing are adapted at t and t1.

Clause 39. The method of clause 37, further comprising:
transmitting, before t3, a signal or data in the direction toward the estimated location of the second UE at t2, based on at least one resource determined by the sidelink sensing performed by the second UE at t1 and the IUC signal received from the second UE.

Clause 40. The method of clause 22, wherein performing the first sidelink sensing at t0 in the first direction towards the estimated location of the second UE at t1 further comprises:
performing, at t0, a sidelink sensing in a direction opposite to the first direction.

Clause 41. The method of clause 22, wherein performing the second sidelink sensing at t1 in the second direction towards the estimated location of the second UE at t2 further comprises:
performing, at t1, a sidelink sensing in a direction opposite to the second direction.

Clause 42. The method of clause 24, wherein performing the third sidelink sensing at t2 in the third direction further comprises:
performing, at t2, a sidelink sensing in a direction opposite to the third direction.

Clause 43. The method of clause 33, wherein, during performing the first sidelink sensing in each of directions towards to the estimated locations of the second UE at t1, t2, t3, and t4, a different reference signal received power (RSRP) threshold is used for each of the directions toward to the estimated locations of the second UE at t1, t2, t3, and t4.

Clause 44. A user equipment (UE) for a sidelink communication, the UE comprising:
a memory storing an instruction; and
a processor configured to execute the instruction stored in the memory to:
determine a spatial filter configuration, the spatial filter configuration being associated with a first time period;
collect sensing information obtained using the spatial filter configuration, the sensing information including at least one of: sidelink resource reservation information, or at least one sidelink reference signal received power (SL-RSRP) measurement of the sidelink communication;
determine one or more candidate resources based on the sensing information;
select one or more resources from the one or more candidate resources for transmission;
re-evaluate, using the spatial filter configuration, the selected one or more resources; and
determine, based on a result of the re-evaluating of the selected one or more resources, whether a re-selection of the one or more resources is triggered.

Clause 45. The UE of clause 44, wherein the UE is a first UE, and the processor is further configured to execute the instruction stored in the memory to:
determine whether a location of a second UE is known to the first UE.

Clause 46. The UE of clause 45, wherein the processor is further configured to execute the instruction stored in the memory to:
select a directed spatial filter configuration as the spatial filter configuration, in response to a determination that the location of the second UE is known to the first UE.

Clause 47. The UE clause 45, wherein the processor is further configured to execute the instruction stored in the memory to:
select a broader spatial filter configuration as the spatial filter configuration, in response to a determination that the location of the second UE is unknown to the first UE.

Clause 48. The UE of clause 44, wherein in selecting the one or more resources from the one or more candidate resources, the processor is further configured to execute the instruction stored in the memory to:
select the one or more resources from the one or more candidate resources semi-persistently.

Clause 49. The UE of clause 44, wherein in selecting the one or more resources from the one or more candidate resources, the processor is further configured to execute the instruction stored in the memory to:
select the one or more resources from the one or more candidate resources up to a maximum number of one or more resource reservations.

Clause 50. The UE of clause 44, wherein the processor is further configured to execute the instruction stored in the memory to:
transmit a signal or data based on the spatial filter configuration and the one or more selected resources, in response to a determination that the re-selection of the one or more resources is not triggered.

Clause 51. The UE of clause 50, wherein the processor is further configured to execute the instruction stored in the memory to:
determine, after the transmitting, whether to update the spatial filter configuration.

Clause 52. The UE of clause 51, wherein the re-selection of the one or more resources is a first re-selection, and the processor is further configured to execute the instruction stored in the memory to:
determine, based on a determination of whether a maximum number of one or more resource reservations is reached, whether a second re-selection of the one or more resources is triggered, in response to a determination that the first spatial filter configuration does not need to be updated.

Clause 53. The UE of clause 52, wherein the processor is further configured to execute the instruction stored in the memory to:
iterate the execution of the instruction from determining the spatial filter configuration, in response to a determination that the second re-selection of the one or more resources is triggered; and
initiate another transmission based on the spatial filter configuration, in response to a determination that the second re-selection of resources is not triggered.

Clause 54. The UE of clause 52, wherein the processor is further configured to execute the instruction stored in the memory to:
iterate the execution of the instruction from determining the spatial filter configuration, in response to a determination that the first spatial filter configuration needs to be updated.

Clause 55. The UE of clause 50, wherein the processor is further configured to execute the instruction stored in the memory to:
iterate the execution of the instruction from collecting the sensing information, in response to a determination that the re-selection of the one or more resources is triggered.

Clause 56. The UE of clause 44, wherein in re-evaluating the selected one or more resources, the processor is further configured to execute the instruction stored in the memory to:
decode one or more signals on a physical sidelink control channel (PSCCH) received from one or more other UEs, the PSCCH being received using the spatial filter configuration; or
measure one or more sidelink reference signal received powers (SL-RSRP) on at least one of PSCCH or physical sidelink shared channel (PSSCH) received from the one or more other UEs, the at least one of PSCCH or PSSCH being received using the spatial filter configuration.

Clause 57. The UE of clause 44, wherein the processor is further configured to execute the instruction stored in the memory to:
determine whether to update the spatial filter configuration, in response to a determination that the re-selection of the one or more resources is not triggered; and
in response to a determination that the re-selection of the one or more resources is triggered, iterate the execution of the instruction from determining the spatial filter configuration or from collecting the sensing information.

Clause 58. The UE of clause 57, wherein the processor is further configured to execute the instruction stored in the memory to:
transmit a signal or data based on the spatial filter configuration, in response to a determination that the spatial filter configuration does not need to be updated.

Clause 59. The UE of clause 58, wherein the re-selection of the one or more resources is a first re-selection, and the processor is further configured to execute the instruction stored in the memory to:
determine, based on a determination of whether a maximum number of resource reservations is reached, whether a second re-selection of the one or more resources is triggered.

Clause 60. The UE of clause 59, wherein the processor is further configured to execute the instruction stored in the memory to:
iterate the execution of the instruction from determining the spatial filter configuration, in response to a determination that the second re-selection of the one or more resources is triggered; and
initiate another transmission based on the spatial filter configuration, in response to a determination that the second re-selection of resources is not triggered.

Clause 61. The UE of clause 57, wherein the processor is further configured to execute the instruction stored in the memory to:
iterate the execution of the instruction from determining the spatial filter configuration, in response to a determination that the spatial filter configuration needs to be updated.

Clause 62. The UE of clause 61, wherein the processor is further configured to execute the instruction stored in the memory to:
select a new spatial filter configuration to replace the spatial filter configuration.

Clause 63. The UE of clause 44, wherein the UE is a first UE, and the spatial filter configuration is determined based on location information of a second UE.

Clause 64. The UE of clause 46, wherein the location of the second UE is known to the first UE based on a reception of a cooperative awareness message (CAM) or a basic safety message (BSM) transmitted from the second UE.

Clause 65. The UE of clause 44, wherein the UE is a first UE, the spatial filter configuration is a first spatial filter configuration, and the first time period is a time period starting at t0 and ending at t2, and wherein in collecting the sensing information obtained using the spatial filter configuration, the processor is further configured to execute the instruction stored in the memory to:
perform, at t0, a first sidelink sensing in a first direction towards an estimated location of a second UE at t1, t1 being a time between t0 and t2; and perform, at t1, a second sidelink sensing in a second direction towards an estimated location of the second UE at t2.

Clause 66. The UE of clause 65, wherein the processor is further configured to execute the instruction stored in the memory to:
transmit, before t2, a signal or data in the first direction towards the estimated location of the second UE at t1, using at least one resource selected based on the first sidelink sensing performed at t0.

Clause 67. The UE of clause 66, wherein a second spatial filter configuration is associated with a second time period that is a time period starting at t2 and ending at t3, and the processor is further configured to execute the instruction stored in the memory to:
perform, at t2, a third sidelink sensing in a third direction towards an estimated location of the second UE at t3.

Clause 68. The UE of clause 67, wherein the processor is further configured to execute the instruction stored in the memory to:
transmit, before t3, a signal or data in the second direction towards the second UE at t2, using at least one resource determined by the second sidelink sensing performed at t1.

Clause 69. The UE of clause 65, wherein the first sidelink sensing and the second sidelink sensing are performed when a difference between t1 and to is greater than a minimum difference and smaller than a maximum difference.

Clause 70. The UE of clause 69, wherein at least one of the minimum difference or the maximum difference is a function of an absolute speed of the first UE and a relative speed of the first UE relative to the second UE.

Clause 71. The UE of clause 69, wherein at least one of the minimum difference or the maximum difference is pre-configured or configured.

Clause 72. The UE of clause 67, wherein the first sidelink sensing and the second sidelink sensing are performed only when the first spatial filter configuration is expected to be changed to the second spatial filter configuration in the second time period.

Clause 73. The UE of clause 65, wherein one or more reference signal received power (RSRP) thresholds used during the first sidelink sensing and the second sidelink sensing are adapted at t0 and t1.

Clause 74. The UE of clause 65, wherein one or more reference signal received power (RSRP) thresholds used during the first sidelink sensing and the second sidelink sensing are adapted based on a spatial filter gain difference.

Clause 75. The UE of clause 66, wherein the second sidelink sensing in the second direction towards the estimated location of the second UE at t2 is performed before transmission of the signal or data in the first direction towards the estimated location of the second UE at t1, wherein sidelink control information (SCI) at the transmission indicates one or more resources to be used at t2, and wherein the processor is further configured to execute the instruction stored in the memory to:
monitor a resource pool while adapting the first spatial filter configuration; and determine whether a re-selection of the one or more resources is triggered.

Clause 76. The UE of clause 44, wherein the UE is a first UE, the spatial filter configuration is a first spatial filter configuration, the first time period is a time period starting at t0 and ending at t2, and wherein in collecting the sensing information obtained using the spatial filter configuration, the processor is further configured to execute the instruction stored in the memory to:
perform, at t0, a first sidelink sensing in each of directions towards estimated locations of a second UE at a plurality of time instances after to including t1, t2, t3, and t4, wherein t2 is a starting point of a second time period and t3 is an end point of the second time period; and
perform, at t1, a second sidelink sensing in each of the directions towards estimated locations of the second UE at a plurality of time instances after t1 including t2, t3, and t4.

Clause 77. The UE of clause 76, wherein the processor is further configured to execute the instruction stored in the memory to:
transmit, before t2, a signal or data to the second UE in the direction towards the estimated location of the second UE at t1, using at least one resource determined from the first sidelink sensing performed at t0.

Clause 78. The UE of clause 77, wherein the processor is further configured to execute the instruction stored in the memory to:
perform, at t2, a third sidelink sensing in each of the directions towards the estimated locations of the second UE at a plurality of time instances after t2 including t3 and t4.

Clause 79. The UE of clause 78, wherein the processor is further configured to execute the instruction stored in the memory to:
transmit, before t3, a signal or data to the second UE in the direction towards the estimated location of the second UE at t2, based on at least one resource determined by the second sidelink sensing performed at t1.

Clause 80. The UE of clause 76, wherein the processor is further configured to execute the instruction stored in the memory to:
receive, from the second UE, an inter-UE coordination (IUC) signal, the IUC signal including information of a sidelink sensing performed by the second UE at t1 in each of directions towards estimated locations of the first UE at the plurality of time instances after t1 including t2, t3, and t4.

Clause 81. The UE of clause 76, wherein one or more reference signal received power (RSRP) thresholds used during the first sidelink sensing and the second sidelink sensing are adapted at t0 and t1.

Clause 82. The UE of clause 80, wherein the processor is further configured to execute the instruction stored in the memory to:
transmit, before t3, a signal or data in the direction toward the estimated location of the second UE at t2, based on at least one resource determined by the sidelink sensing performed by the second UE at t1 and the IUC signal received from the second UE.

Clause 83. The UE of clause 65, wherein in performing the first sidelink sensing at t0 in the first direction towards the estimated location of the second UE at t1, the processor is further configured to execute the instruction stored in the memory to:
perform, at t0, a sidelink sensing in a direction opposite to the first direction.

Clause 84. The UE of clause 65, wherein in performing the second sidelink sensing at t1 in the second direction towards the estimated location of the second UE at t2, the processor is further configured to execute the instruction stored in the memory to:
perform, at t1, a sidelink sensing in a direction opposite to the second direction.

Clause 85. The UE of clause 67, wherein in performing the third sidelink sensing at t2 in the third direction, the processor is further configured to execute the instruction stored in the memory to:
perform, at t2, a sidelink sensing in a direction opposite to the third direction.

Clause 86. The UE of clause 76, wherein, during performing the first sidelink sensing in each of directions towards to the estimated locations of the second UE at t1, t2, t3, and t4, a different reference signal received power (RSRP) threshold is used for each of the directions toward to the estimated locations of the second UE at t1, t2, t3, and t4.

Clause 87. A non-transitory computer-readable medium storing instructions that are executable by one or more processors of a user equipment (UE) for a sidelink communication to perform a method, the method comprising: determining a spatial filter configuration, the spatial filter configuration being associated with a first time period;
collecting sensing information obtained using the spatial filter configuration, the sensing information including at least one of: sidelink resource reservation information, or at least one sidelink reference signal received power (SL-RSRP) measurement of the sidelink communication; determining one or more candidate resources based on the sensing information;
selecting one or more resources from the one or more candidate resources for transmission;
re-evaluating using the spatial filter configuration, the selected one or more resources; and
determining, based on a result of the re-evaluating of the selected one or more resources, whether a re-selection of the one or more resources is triggered.

1. A method for resource selection in a sidelink communication, the method comprising:
determining, by a user equipment (UE), a spatial filter configuration, the spatial filter configuration being associated with a first time period;
collecting, by the UE, sensing information obtained using the spatial filter configuration, the sensing information including at least one of: sidelink resource reservation information, or at least one sidelink reference signal received power (SL-RSRP) measurement of the sidelink communication;
determining, by the UE, one or more candidate resources based on the sensing information;
selecting, by the UE, one or more resources from the one or more candidate resources for transmission;
re-evaluating, by the UE, using the spatial filter configuration, the selected one or more resources; and
determining, based on a result of the re-evaluating of the selected one or more resources, whether a re-selection of the one or more resources is triggered.

2. The method of claim 1, wherein the UE is a first UE, and the method further comprises:
determining, by the first UE, whether a location of a second UE is known to the first UE.

3. The method of claim 2, further comprising:
selecting a directed spatial filter configuration as the spatial filter configuration, in response to a determination that the location of the second UE is known to the first UE.

4. The method of claim 2, further comprising:
selecting a broader spatial filter configuration as the spatial filter configuration, in response to a determination that the location of the second UE is unknown to the first UE.

5. The method of claim 1, wherein selecting the one or more resources from the one or more candidate resources further comprises:
selecting, by the UE, the one or more resources from the one or more candidate resources semi-persistently.

6. The method of claim 1, wherein selecting the one or more resources from the one or more candidate resources further comprises:
selecting, by the UE, the one or more resources from the one or more candidate resources up to a maximum number of one or more resource reservations.

7. The method of claim 1, further comprising:
transmitting a signal or data based on the spatial filter configuration and the one or more selected resources, in response to a determination that the re-selection of the one or more resources is not triggered.

8. The method of claim 7, further comprising:
determining, after the transmitting, whether to update the spatial filter configuration.

9. The method of claim 7, further comprising:
iterating the method from collecting the sensing information, in response to a determination that the re-selection of the one or more resources is triggered.

10. The method of claim 1, wherein the re-evaluating the selected one or more resources further comprises at least one of:
decoding one or more signals on a physical sidelink control channel (PSCCH) received from one or more other UEs, the PSCCH being received using the spatial filter configuration; or
measuring one or more sidelink reference signal received powers (SL-RSRP) on at least one of the PSCCH or physical sidelink shared channel (PSSCH) received from the one or more other UEs, the at least one of the PSCCH or the PSSCH being received using the spatial filter configuration.

11. The method of claim 1, further comprising:
determining whether to update the spatial filter configuration, in response to a determination that the re-selection of the one or more resources is not triggered; and
in response to a determination that the re-selection of the one or more resources is triggered, iterating the method from determining the spatial filter configuration or from collecting the sensing information.

12. The method of claim 11, further comprising:
transmitting a signal or data based on the spatial filter configuration, in response to a determination that the spatial filter configuration does not need to be updated.

13. The method of claim 11, further comprising:
iterating the method from determining the spatial filter configuration, in response to a determination that the spatial filter configuration needs to be updated.

14. The method of claim 1, wherein the UE is a first UE, and the spatial filter configuration is determined based on location information of a second UE.

15. The method of claim 1, wherein the UE is a first UE, the spatial filter configuration is a first spatial filter configuration, and the first time period is a time period starting at t0 and ending at t2, and wherein collecting the sensing information obtained using the spatial filter configuration comprises:
performing, at t0, a first sidelink sensing in a first direction towards an estimated location of a second UE at t1, t1 being a time between t0 and t2; and
performing, at t1, a second sidelink sensing in a second direction towards an estimated location of the second UE at t2.

16. The method of claim 15, further comprising:
transmitting, before t2, a signal or data in the first direction towards the estimated location of the second UE at t1, using at least one resource selected based on the first sidelink sensing performed at t0.

17. The method of claim 15, wherein the first sidelink sensing and the second sidelink sensing are performed when a difference between t1 and t0 is greater than a minimum difference and smaller than a maximum difference.

18. The method of claim 1, wherein the UE is a first UE, the spatial filter configuration is a first spatial filter configuration, the first time period is a time period starting at t0 and ending at t2, and wherein collecting the sensing information obtained using the spatial filter configuration comprises:
performing, at t0, a first sidelink sensing in each of directions towards estimated locations of a second UE at a plurality of time instances after to including t1, t2, t3, and t4, wherein t2 is a starting point of a second time period and t3 is an end point of the second time period; and
performing, at t1, a second sidelink sensing in each of the directions towards estimated locations of the second UE at a plurality of time instances after t1 including t2, t3, and t4.

19. A user equipment (UE) for a sidelink communication, the UE comprising:
a memory storing an instruction; and
a processor configured to execute the instruction stored in the memory to:
determine a spatial filter configuration, the spatial filter configuration being associated with a first time period;
collect sensing information obtained using the spatial filter configuration, the sensing information including at least one of: sidelink resource reservation information, or at least one sidelink reference signal received power (SL-RSRP) measurement of the sidelink communication;
determine one or more candidate resources based on the sensing information;
select one or more resources from the one or more candidate resources for transmission;
re-evaluate, using the spatial filter configuration, the selected one or more resources; and
determine, based on a result of the re-evaluating of the selected one or more resources, whether a re-selection of the one or more resources is triggered.

20. A non-transitory computer-readable medium storing instructions that are executable by one or more processors of a user equipment (UE) for a sidelink communication to perform a method, the method comprising:
determining a spatial filter configuration, the spatial filter configuration being associated with a first time period;
collecting sensing information obtained using the spatial filter configuration, the sensing information including at least one of: sidelink resource reservation information, or at least one sidelink reference signal received power (SL-RSRP) measurement of the sidelink communication;
determining one or more candidate resources based on the sensing information;
selecting one or more resources from the one or more candidate resources for transmission;
re-evaluating using the spatial filter configuration, the selected one or more resources; and
determining, based on a result of the re-evaluating of the selected one or more resources, whether a re-selection of the one or more resources is triggered.
